(19) United States
(12) Patent Application Publication
(10) Pub. No.: US 2008/0162558 A1
(43) Pub. Date: Jul. 3, 2008

(54) CUSTOMIZABLE USER INTERFACE FOR MULTI-PRODUCT INSTALLATION

(75) Inventor: Siddhartha Ashok RAO, Sandhausen (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/618,780

(22) Filed: Dec. 30, 2006

(51) Int. Cl. G06F 7/00

(52) U.S. Cl. 707/104.1

(57) ABSTRACT

A system and method is provided for providing customized input requests for installing products from a distribution server responsive to a request to install the product(s) on a workstation, wherein the customized input requests are determined based on the product(s). The method also includes installing the product(s) on the workstation based on a user input.

### BACKGROUND

Enterprises often have a plurality of workstations connected to one or more sewers through a network. Each workstation may be configured to execute one or more applications for a user at the workstation. Each application may have a lifecycle, including creation, distribution, installation, updating, and de-installation.

Each application may have a set of unique inputs required, a set of required pre-requisite applications already installed on the workstation, a set of optional components which may or may not be installed selected by the user, a set of unique messages to be displayed to the user during installation.

With large enterprise networks that include numerous workstations and multiple applications, installing and maintaining applications on can become time-consuming and complex.

### BRIEF DESCRIPTION OF THE DRAWINGS

FIG. 1A shows an example screenshot of a user interface for installing products on a workstation in an enterprise network in accordance with an embodiment of the present invention.

FIG. 1B shows another example screenshot of a user interface for installing product(s) on a workstation in an enterprise network in accordance with an embodiment of the present invention.

FIG. 1C shows another example screenshot of a user interface for installing product(s) on a workstation in an enterprise network in accordance with an embodiment of the present invention.

FIG. 2 shows an example procedure to provide a user interface for installing product(s) on a workstation in an enterprise network in accordance with an embodiment of the present invention.

FIG. 3 shows an example system to provide a user interface for installing product(s) on a workstation in an enterprise network in accordance with an embodiment of the present invention.

FIG. 4 shows an example product database in accordance with an example embodiment of the present invention.

### DETAILED DESCRIPTION

A method and system is provided for creating customizable user interface for installing multiple applications on a workstations or a second computing device or computer readable medium, in a network. An application may be a software product with multiple components that is installed onto a workstation, where it is executed for a user. Programmers may create and distribute the product by installing the product and a product database on a distribution server. The product database may include product-relevant information for the associated product's installation. The distribution server may then install the application onto one or more workstations using the information of the product database.

Generally, a product is comprised of component(s). A component, or installation component, may include file(s), registry keys, etc. Installation of a component effects an installation of everything included in that product component. Likewise, uninstallation of a component effects a deinstallation of everything included in that product component. In an example embodiment of the present invention, a system and method for installation or deinstallation of a component of a software product is provided. For example, if Product A has two individually selectable components (i.e., neither component requires the other) named A.1 and A.2, and a user selects component A.2 to be installed, then the customization installation of product A, component A.2 is effected and the user may be prompted for associated parameters for A.2 installation. Such parameters include a location address. Later, if the user decides it wants to install component A.1 as well, the distribution server, or installation server, on the server detects the location parameters from the component A.2 installation and does not require the user to reenter the information.

An example embodiment of the present invention may include a method for providing a product for installation from a distribution server. The method may include responsive to a request to add the product to the distribution server, updating a distribution database of the distribution server with at least one product database associated with the respective product. The method may include responsive to a request to install the product on a workstation, displaying customized input requests, wherein the customized input requests are determined based on the at least one product database. The method may include installing the product on the workstation based on a user input. The user input may be a user selection of the at least one product for installation. The user selection may be made using a user interface. The method may include responsive to the request to install the product on a workstation, further displaying customized messages and customized install options, wherein the customized messages and customized install options are determined based on the product database. The customized install options may be further determined based on the user input. The customized input requests may be determined using data in a user interface section or layer of the at least one database associated with the respective product. The user input may include a selection of multiple available products for installation. The customized input requests may include an installation path for the product. The customized input requests may include a proxy server address for the product. The product database may include an installation information. The installation information may include information concerning files to copy when installing the product. In an embodiment, in response to a request e.g. by an administrator, by an authorized person, by an authorized entity, by a person other than the user, a second product is added to the distribution server, updating the distribution database, or installation server database, with a second product database associated with the second product. The method may include responding to a request to installing the second product on a workstation, displaying a second set of customized input requests, wherein the second set of customized input requests are determined based on the second product database. The method may include installing the second product on the workstation based on a second input by the user received in response to the set of second customized input requests.

Another example embodiment of the present invention may include a system for providing a product for installation from a distribution server. The system may include a distribution server, and a workstation, the workstation being in communication with the distribution server. The system may include one or more products stored on the distribution server for installation to the workstation. The system may include one or more product databases, the one or more product databases being associated with the product. The system may include a user interface configured to display customized input requests, wherein the customized input requests are determined based on the product database in response to a request to install the product on the workstation. The product database may include customized messages and customized install options, wherein the customized messages and the customized install options are displayed by the user interface. The customized input requests may be determined using information or data in a user interface section of the at least one database associated with the tree. The product database may include an installation information. The system may include a second product stored on the distribution server for installation to the workstation. The system may include a second product database, the product database associated with the product, wherein the user interface is further configured to display a second set of customized input requests, wherein the second set of customized input requests are determined based on the second product database. The distribution server may include a distribution database which stores the product database. The workstation may communicate with the distribution server over a network.

Another example embodiment of the present invention may include a computer-readable medium including instructions adapted to execute a method providing a product for installation from a distribution server. The method may include responsive to a request to add the product to the distribution server, updating a distribution database of the distribution server with a product database associated with the product. The method may include responsive to a request to install the product on a workstation, displaying customized input requests, wherein the customized input requests are determined based on the product database. The method may include installing the product on the workstation based on a user input. The method may include responsive to the request to install the product on a workstation, further displaying customized messages and customized install options, wherein the customized messages and customized install options are determined based on the product database. The customized input requests may be determined from a user interface information of the product database. The product database nay include an installation information. The method may include responsive to a request to add a second product to the distribution server, updating the distribution database with a second product database associated with the second product. The method may include responsive to a request to install the second product on a workstation, displaying a second set of customized input requests, wherein the second set of customized input requests are determined based on the second product database. The method may include installing the second product on the workstation based on a second input received in response to the set of second customized input requests.

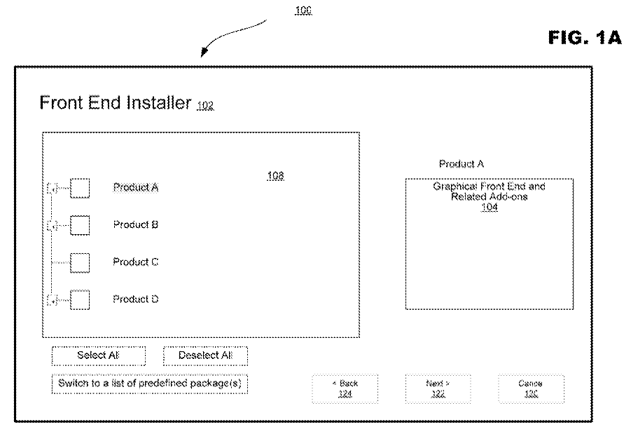

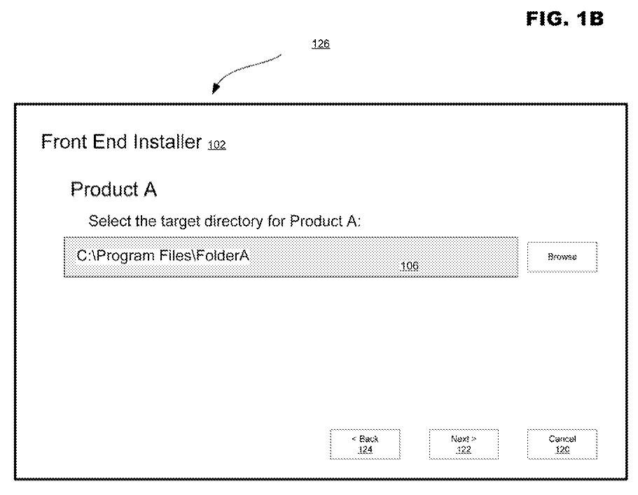

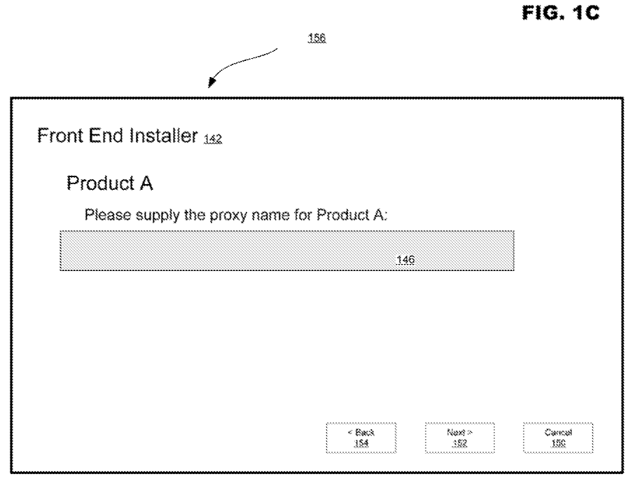

FIG. 1A shows an example screenshot of a user interface for installing products on a workstation in an enterprise network in accordance with an embodiment of the present invention. For example, the user interface may be displayed to the user after a product has been requested to be installed on a workstation.

An example screenshot 100 may display a user interface customized for the installation of the product. A title 102 may be displayed. The title 102 may be a title of the product, such as “Front End Installer”.

A description 104 may be displayed. For example, the description 104 may be text describing the product to be installed and any special instructions to the user for the installation process. The product to be installed may be selected from the list 108. For example, the description 104 may also describe the groups which are allowed to install the product, pre-requisite components that must be installed before the selected product may be installed.

A list of products available for installation 108 may be displayed, along with components associated with each product. For example, components associated with each product may be displayed in a tree format with its associated product. (Not depicted.) The checkboxes allow the user to select which products to install.

Each component of the product may be displayed if the tree is expanded, and related to required components of the same product or different product. The check boxes may indicate a user's selection of a set of components to of the product to be installed. The check boxes may be pre-checked to indicate a default installation configuration.

Button 120 may allow a user to cancel an installation. For example, the user may decide not to install the product after seeing the list of required components, or may be informed that a required component from another product has not yet been installed on the workstation.

Button 122 may allow the user to continue an installation. Button 124 may allow the user to return to a previous step in the installation.

FIG. 1B shows a second example screenshot of a user interface for installing products on a workstation in an enterprise network in accordance with an embodiment of the present invention.

A second screenshot 126 may display a user interface customized for the installation of the product. A title 102 may be displayed. The title 102 may be a title of the product, such as “Front End Installer”. The title 102 may alternatively include a number of steps remaining in the installation process.

A destination 106 may be displayed along with an input field. The destination 106 may be a requested input. The destination 106 may receive the user's input of where the product should be installed. For example, the destination 106 may be a file folder in the file system of the workstation. The destination 106 may be displayed only if the product to be installed requires it as a customized input request.

Button 120 may allow a user to cancel an installation. For example, the user may decide not to install the product after seeing the list of required components, or may be informed that a required component from another product has not yet been installed on the workstation.

Button 122 may allow the user to continue an installation. Button 124 may allow the user to return to a previous step in the installation.

FIG. 1C shows a third example screenshot of a user interface for installing products on a workstation in an enterprise network in accordance with an embodiment of the present invention.

A second screenshot 156 may display a user interface customized for the installation of the product. As in the other examples, a title 142 may be displayed. The title 142 may be a title of the product, such as “Front End Installer”. The title 142 may alternatively include a number of steps remaining in the installation process.

A destination 146 may be displayed along with an input field. The destination 146 may be a requested input. The destination 146 may receive the user's input of where the product should be installed. In this example, the destination 146 is a proxy name for the product. For example, the destination 146 may be a file folder in the file system of the workstation. The destination 146 may be displayed only if the product to be installed requires it as a customized input request.

Button 150 may allow a user to cancel an installation. Button 152 may allow the user to continue an installation. Button 154 may allow the user to return to a previous step in the installation.

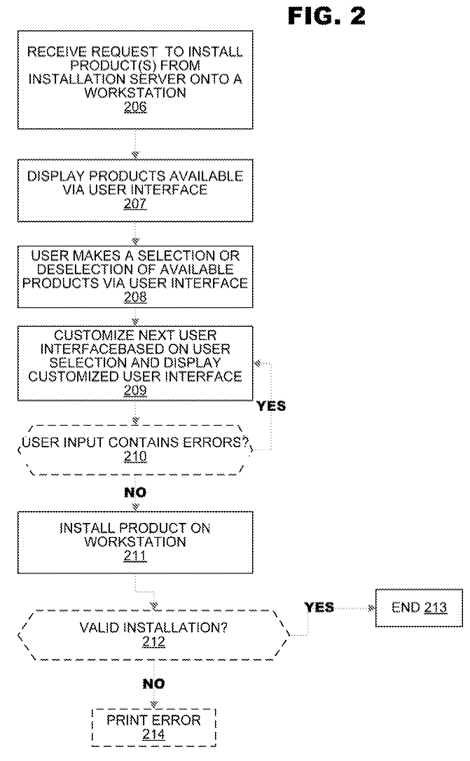

FIG. 2 shows an example procedure, to provide a user interface for installing products on a workstation in an enterprise network in accordance with an embodiment of the present invention. For example, the procedure may execute on a system as depicted in FIG. 2. The procedure may execute on an enterprise network including at least one workstation and a distribution server. Products may be applications, patches, updates or upgrades that need to be installed on each of the workstations in the enterprise network. The product may first be stored on a distribution server, along with an associated product data. The distribution server may then install the product on each workstation as requested.

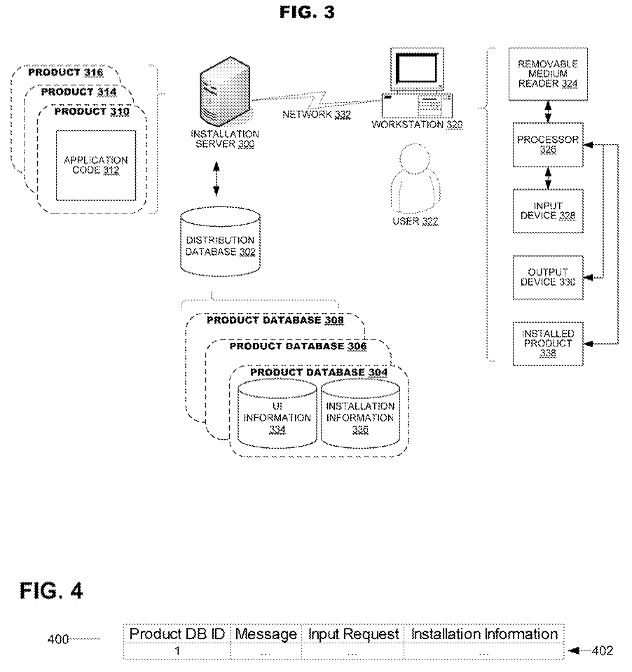

A distribution server or an installation server may contain one or more products available for installation. The one or more products may be saved on a storage medium, such as a local hard drive, a network drive or a removable medium. Each product may have one or more product databases associated with it. The one or more product databases may include information relating to the product and its installation. For example, the product database may be as depicted in FIG. 4. For example, the product database may include user interface information relating to a user interface of the installation process, and installation information relating to the installation process.

In 206, a request may be received to install (or uninstall) one or more products from the distribution server, or installation server, onto a workstation. For example, the request may be received from an administrator who is installing the product(s) on a subset of all workstations in the enterprise network. Alternatively, the request may be received from a user of the workstation who requires the product(s) on the workstation. In 207, the available products may be displayed via a user interface. In 208, the administrator or user makes a selection or deselection of one or more products. In 209, the next user interface is customized based on the selection or deselection, and the resulting customized user interface is displayed. For example, the user interface may be customized for the product based on information in the product database. The user interface may include customized messages displayed to the user, customized input requests and customized install options.

In 210, the procedure may optionally check the user inputs for error. For example, installation destination may be required to be a location on the workstation and requisite components of the product are selected for installation. The procedure may also check to make sure the user or administrator has permissions to install the product on the workstation.

In 211, the procedure may install the product on the workstation with a configuration determined by the user's inputs received in 208.

In 212, the procedure may optionally check whether the installation finished validly. If yes, the procedure may end in 213. If no, the procedure may print an error message and/or make an audible error signal in 214 and/or take any other steps necessary to notify a user or an administrator that the installation failed. Such other steps may also include an opportunity for the user input to be corrected, e.g., via another user interface.

FIG. 3 depicts an example system to provide a user interface for installing products on a workstation in an enterprise network in accordance with an embodiment of the present invention. For example, the system may be an enterprise network including one or more servers, a plurality of workstations and products which are installed on each workstation. The server and workstations may communicate over a network, for example, an Ethernet network, a virtual private network, a wide area network, a local area network, or the Internet. The products may be those necessary or helpful to users in the enterprise network and communicate with the server.

The system may include a distribution server 300. The distribution server 300 may be configured to store multiple products ready for installation, and to install multiple products over the network onto workstations when requested.

For example, the distribution server 300 may be located in a central location of the enterprise network and in communication with a plurality of workstations over a network. While only one distribution server 300 is depicted, it is understood that multiple distribution servers may be present in the system. Each distribution server may, for example, be responsible for carrying certain products ready for installation. Alternatively, each distribution server may, for example, be responsible for installing products on certain workstations.

The distribution server 300 may include a plurality of products 310, 314, 316 ready to install on workstations. It is understood that the distribution server 300 may include any number of products.

Each product may include an application code, and any other required components to install the product onto a workstation. For example, product 310 includes application code 312.

The distribution server 300 may be in communication with a distribution database 302. For example, the distribution database 302 may be a relationship database including a plurality of product databases 304, 306 and 308. It is understood that the distribution server 300 may include any number of product databases.

Each product database may be associated with a product included in the distribution server 300 and include information relevant to the installation of the associated product. For example, product database 304 may include user interface information 334 and installation information 336.

User interface information 334 may include a list of customized inputs that must be received from a user. For example, the user interface information 334 may include an installation destination location, a list of option components of the product the user desires installed and specialized output messages to display to the user during an installation.

Installation information 336 may include product-specific information necessary to the distribution server 300 and a workstation to install the product on the workstation. For example, the installation information 336 may include a name of the product, a proxy address specific to the installation or an address of a server where the product installation should be registered.

The system may include a workstation 320 in communication with the distribution server 300 over the network 332. While only one workstation is depicted in FIG. 3, it is understood that any number of workstations may be included in the system and be in communication with the distribution server 300.

The workstation 320 may be configured to store one or more installed products, such as installed product 338. For example, installed product 338 may be a product previously stored on distribution server 300 and later installed on the workstation 320.

The workstation 320 may include a removable medium reader 324, a processor 326, an input device 328 and an output device 330. The removable medium reader 324 may be configured to read a removable medium, such as a CD or a DVD. The processor 326 may be configured to execute an application, such as an installed product. The input device 328 and output device 330 may interface with a user 322. For example, the workstation 320 may be configured to execute a GUI over the input device 328 and output device 330, through which the user may interact with the installed product 338 when it is executed on the workstation 320.

FIG. 4 illustrates an example product database in accordance with an example embodiment of the present invention. The product database may be stored in a distribution database and associated with a product in the system as depicted in FIG. 3. The product database may be stored as a product database structure 400 and include a record 402.

It will be appreciated that the product database structure 400 may be stored in a variety of ways. For example, it may be stored as a tab delimited or comma delimited flat file, in a relational database, an XML document or another storage method accessible to the distribution server.

The record 402 may contain a variety of information, such as a product database ID 404. For example, each product in the system may be associated with an identifier to help identify the product. The identifier may be an alpha-numeric sequence of characters and may be unique among all products ever created, all products available over the distribution server, or among some other universe of products.

The record 402 may include customized messages 406. Customized messages 406 may be a list of messages to be displayed to the user during installation of the product, each message associated with a condition of when the message should be displayed on the workstation. For example, the customized messages may include a title and a description of the product which is displayed when the installation process of the product is started.

The record 402 may include customized input request 408. Customized input request 408 may be a list of input requests to be made to the user during installation of the product, each input request associated with a condition of when the input request should be made on the workstation. For example, the input requests may include a request for a destination location of the product on the workstation where the product is to be installed.

The record 402 may include customized installation information 410. Customized installation information 410 may be a list of installation information available to the installation process of the product. For example, the installation information may include a registration server to register the product after installation is complete. Another example installation information may include an address of a proxy server to be used in the installation process.

Several embodiments of the present invention are specifically illustrated and described herein. However, it will be appreciated that modifications and variations of the present invention are covered by the above teachings and within the purview of the claims without departing from the spirit and intended scope of the invention.

It will be appreciated that while the description above describes installing applications available on a distribution server to a computing device requiring the application, the distribution server may be integrated with the workstation. For example, the workstation may include its own distribution database and applications may be distributed on removable medium, such as CDs or DVDs. The workstation, or computing device, then installs the application from the removable medium and the distribution database is updated.

What is claimed is:

1. A method for providing at least one product for installation from a distribution server, comprising:
providing a distribution server having at least one product, each of the at least one product being associated with at least one product database;
responsive to a request to install the at least one product from the distribution server onto a computing device, displaying any customized input requests, the any customized input requests determined based on the at least one product database; and
installing the at least one product on the computing device based on a user input to the any customized input requests,
wherein the method provides for the essentially simultaneous installation of more than one of the at least one product on the computing device.

2. The method of claim 1, wherein each product of the at least one product is comprised of product components capable of being individually selectable.

3. The method of claim 2, wherein the request to install the at least one product is a request to install a first product component of the respective product, further comprising,
installing the at least one product on the computing device based on the user input to the any customized input requests;
installing a second product component of the respective product on the computing device using the user input to the any customized input requests from installation of the first product component.

4. The method of claim 1, further comprising:
responsive to the request to install the at least one product on the computing device, displaying any customized messages and any customized install options, wherein the any customized messages and any customized install options are determined from the at least one database associated with the at least one product.

5. The method of claim 4, wherein the customized install options are further determined based on the user input, wherein the user input includes a user selection of the at least one product for installation via a user interface.

6. The method of claim 4, wherein the customized install options are further determined based on the user input, wherein the user input includes a user selection of multiple products available for installation from the distribution server.

7. The method of claim 11, wherein the customized input requests are determined from information contained in a user interface layer of the at least one database of the at least one product.

8. The method of claim 1, wherein the customized input requests include an installation path for the at least one product.

9. The method of claim 1, wherein the customized input requests include a proxy server address.

10. The method of claim 1, further comprising:
providing the distribution server having at least one second product, each of the at least one second product being associated with at least one second product database;
responsive to a request to install the at least one second product on a computing device, displaying an at least one second customized input request, wherein the at least one second customized input request is determined based on the at least one second product database; and
installing the at least one second product on the computing device based on an at least one second input received in response to the at least one second customized input request.

11. The method of claim 10, wherein the request to add the at least one product and the at least one second product to the distribution server and updating the distribution server is made by one of an authorized entity, an authorized automated entity, an entity different from the user, and a distribution server administrator.

12. A system for providing at least two products for installation, comprising:
a distribution server;
a computing device, the computing device being in communication with the distribution server;
at least two products stored on the distribution server for installation to the computing device;
at least one product database, the at least one product database being associated with at least one of the at least two products; and
a user interface, the user interface being configured to display at least one customized input request, wherein the at least one customized input request is determined based on the at least one product database in response to a request to install the at least two products on the computing device.

13. The system of claim 12, wherein the at least one product database includes a customized message and a customized install option, wherein the customized message and the customized install option are displayed by the user interface.

14. The system of claim 12, wherein the at least one customized input request is determined based on data in a user interface section of the at least one database associated with the respective product, and the request to install the at least two products is in response to a user selection of the at least two products via the user interface.

15. The system of claim 12, wherein the computing device communicates with the distribution server via at least one of a network, a computer readable medium, a CDROM, a DVD, a flash memory, a disk, and a hardwire connection between the computing device and the distribution server.

16. A computer-readable medium including instructions adapted to execute a method providing at least two products for installation, the method comprising,
responsive to a request to install at least two products on a computing device, displaying any customized input requests, wherein the any customized input requests are determined from a respective at least one database associated with each of the at least two products; and
installing the at least two products on the computing device based on a user input.

17. The computer-readable medium of claim 16, the method further comprising:
displaying any customized messages and customized install options, wherein the any customized messages and customized install options are determined based on the respective at least one database associated with the at least two products.

18. The computer-readable medium of claim 16, wherein the customized input requests are determined from a user interface information of the respective at least one database associated with the at least two products.

19. The computer-readable medium of claim 16, wherein the product database includes an installation information.

20. The computer-readable medium of claim 16, further comprising:
responsive to a request to install the second product on a computing device, displaying a second set of customized input requests, wherein the second set of customized input requests are determined based on the second product database, and
installing the second product on the workstation based on a second input received in response to the set of second customized input requests.
